(19) United States
(12) Patent Application Publication
(10) Pub. No.: US 2008/0253828 A1
(43) Pub. Date: Oct. 16, 2008

(54) LEVER-ARCH TYPE FILE MECHANISM

(76) Inventor: Hung Yu CHENG, Hong Kong (CN)

Correspondence Address: OSTROLENK FABER GERB & SOFFEN, 1180 AVENUE OF THE AMERICAS, NEW YORK, NY, 100368403, US

(21) Appl. No.: 11/857,731

(22) Filed: Sep. 19, 2007

(30) Foreign Application Priority Data
Apr. 11, 2007 (EP) 07251547.1

(51) Int. Cl. B42F 13/14

(52) U.S. Cl. 402/66

(57) ABSTRACT

A lever-arch type file mechanism (100, 200) is disclosed as including a base (102, 202), two rings extending upwardly from the base (102, 202), each ring a post (106, 206) fixed to the base (102, 202) and an arch (124, 207) movable relative to the base (102, 202) and the post (106, 206), a lever assembly (108, 208) movable relative to the base (102, 202) between two stable configurations to pivot the arches (124, 207) relative to the posts (106, 206) to selectively move the rings between a ring-closed configuration and a ring-open configuration, and the lever assembly (108, 208) includes at least a first link (136, 216) and a second link (132, 212) connected with each other, and the first link (136, 216) is pivotable relative to the base (102, 202) about a first axis (P-P, W-W) fixed relative to the base (102, 202) and that the second link (132, 212) is pivotable relative to the base (102, 202) about a second axis (S-S, T-T) fixed relative to the base (102, 202), and during movement of the lever assembly (108, 208) between the two stable configurations, the first link (136, 216) is pivotable relative to the base (102, 202) through a first angle (α, θ) and the second link (132, 212) is pivotable relative to the base (102, 202) through a second angle (β, Φ) which is larger than the first angle (α, θ).

This invention relates to a device for retaining a stack of hole-punched paper in a file and, in particular such a device comprising a lever-arch type file mechanism.

In a conventional lever-arch type file mechanism, a one-armed lever is provided for pivoting a pair of arches relative to a pair of fixed posts to allow pieces of hole-punched paper to be retrieved from or inserted into the file mechanism, and for closing the posts and arches to form a pair of closed rings to retain the paper therein. The pair of arches are integrally formed with an intervening shaped portion on which a roller attached to the lever travels during pivotal movement of the lever, to effect opening or closing of the ring pairs.

In such a conventional file mechanism, when the ring pairs are open, the upper free end of the lever is very close to, and sometimes even contacts, one of the arches. Thus, when the ring pairs are open, paper can only be retrieved from or inserted into the pair of fixed posts, but no paper can be retrieved from or inserted into the pair of pivotable arches.

It is thus an object of the present invention to provide a lever-arch type file mechanism and a lever-arch type file with such a mechanism in which the aforesaid shortcomings are mitigated, or at least to provide a useful alternative to the public.

According to a first aspect of the present invention, there is provided a lever-arch type file mechanism including a base; at least two rings extending upwardly from the base, each said ring including a post member fixed to said base and an arch member movable relative to said base and said post member; a lever assembly movable relative to said base between two stable configurations to pivot said arch members relative to said post members to selectively move said rings between a ring-closed configuration and a ring-open configuration; wherein said lever assembly includes at least a first link member and a second link member connected with each other; characterized in that said first link member is pivotable relative to said base member about a first axis fixed relative to said base and that said second link member is pivotable relative to said base member about a second axis fixed relative to said base.

According to a second aspect of the present invention, there is provided a lever-arch type file mechanism including a base; at least two rings extending upwardly from the base, each said ring including a post member fixed to said base and an arch member movable relative to said base and said post member; a lever assembly movable relative to said base between two stable configurations to pivot said arch members relative to said post members to selectively move said rings between a ring-closed configuration and a ring-open configuration; wherein said lever assembly includes at least a first link member and a second link member connected with each other; characterized in that during movement of said lever assembly between said two stable configurations, said first link member is pivotable relative to said base member through a first angle and that said second link member is pivotable relative to said base member through a second angle which is different from said first angle.

According to a third aspect of the present invention, there is provided a lever-arch type file including a lever-arch type file mechanism fixedly secured to a substrate, said lever-arch type file mechanism including a base; at least two rings extending upwardly from the base, each said ring including a post member fixed to said base and an arch member movable relative to said base and said post member; a lever assembly movable relative to said base between two stable configurations to pivot said arch members relative to said post members to selectively move said rings between a ring-closed configuration and a ring-open configuration; wherein said lever assembly includes at least a first link member and a second link member connected with each other; characterized in that said first link member is pivotable relative to said base member about a first axis fixed relative to said base and that said second link member is pivotable relative to said base member about a second axis fixed relative to said base.

According to a fourth aspect of the present invention, there is provided a lever-arch type file including a lever-arch type file mechanism fixedly secured to a substrate, said lever-arch type file mechanism including a base; at least two rings extending upwardly from the base, each said ring including a post member fixed to said base and an arch member movable relative to said base and said post member; a lever assembly movable relative to said base between two stable configurations to pivot said arch members relative to said post members to selectively move said rings between a ring-closed configuration and a ring-open configuration; wherein said lever assembly includes at least a first link member and a second link member connected with each other; characterized in that during movement of said lever assembly between said two stable configurations, said first link member is pivotable relative to said base member through a first angle and that said second link member is pivotable relative to said base member through a second angle which is different from said first angle.

Embodiments of lever-arch type file mechanisms according to the present invention will now be described, by way of examples only, with reference to the accompanying drawings, in which:

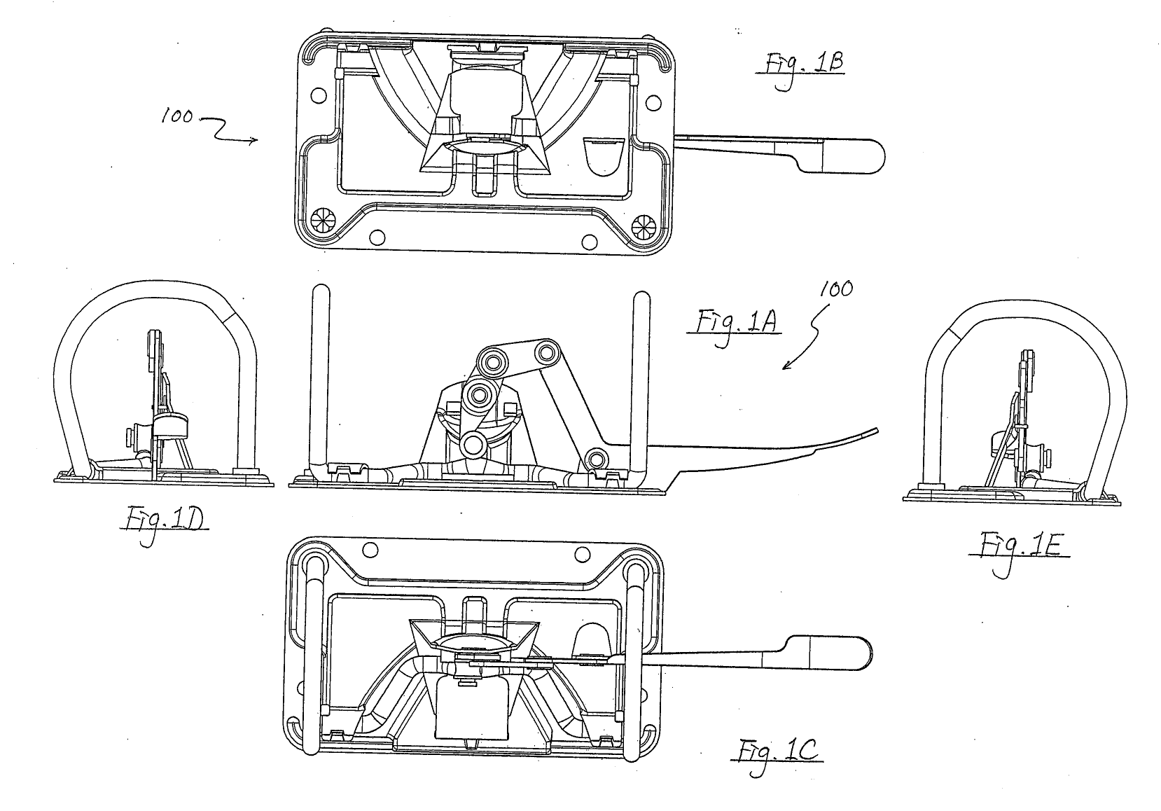

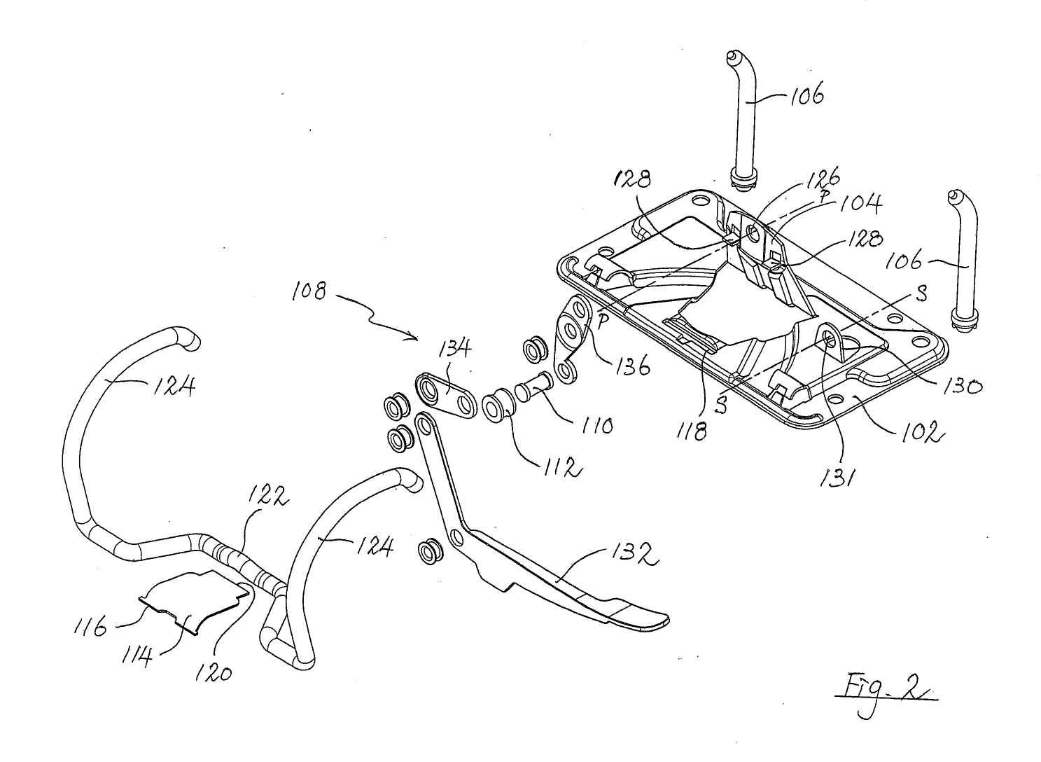

FIG. 1A is a front view of a lever-arch type file mechanism according to a first embodiment of the present invention in a ring-closed configuration;

FIG. 1B is a bottom view of the mechanism shown in FIG. 1A;

FIG. 1C is a top view of the mechanism shown in FIG. 1A;

FIG. 1D is a right side view of the mechanism shown in FIG. 1A;

FIG. 1E is a left side view of the mechanism shown in FIG. 1A;

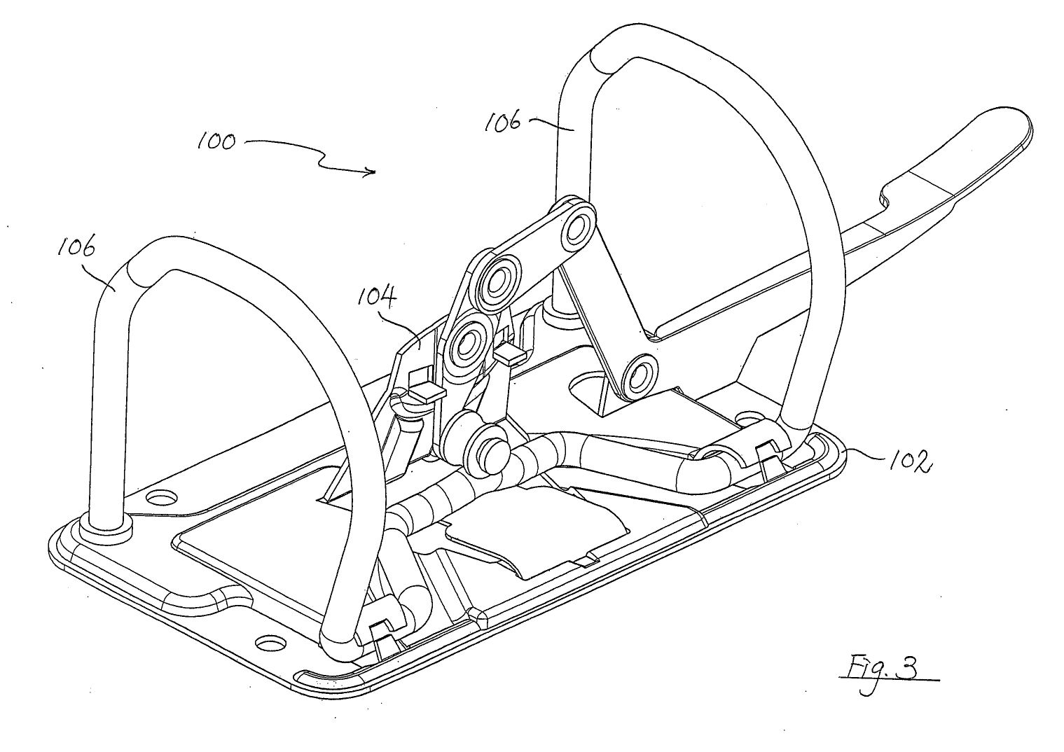

FIG. 2 is an exploded perspective view of the mechanism shown in FIG. 1A;

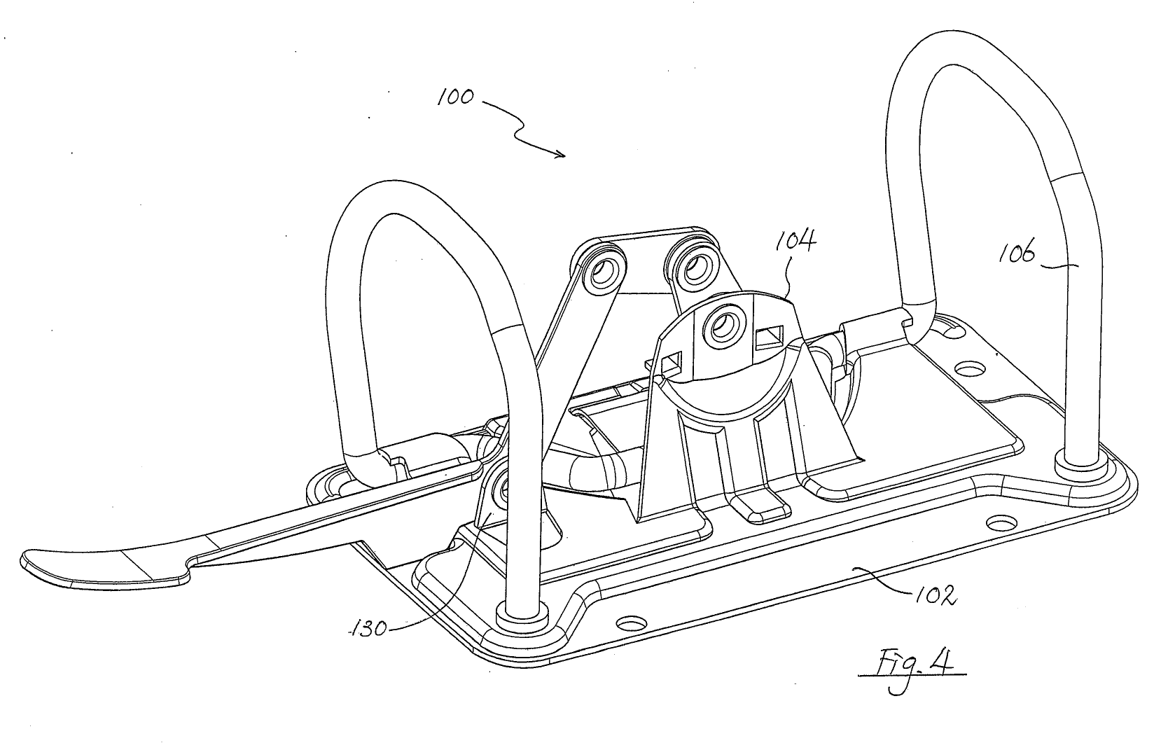

FIG. 3 is a front perspective view of the mechanism shown in FIG. 1A;

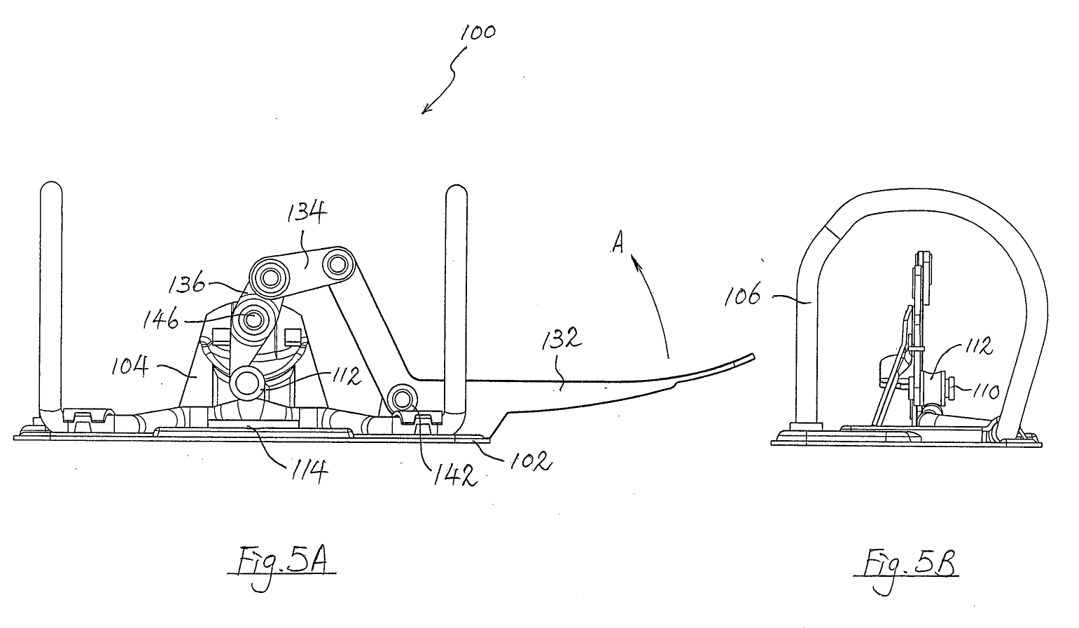

FIG. 4 is a rear perspective view of the mechanism shown in FIG. 1A;

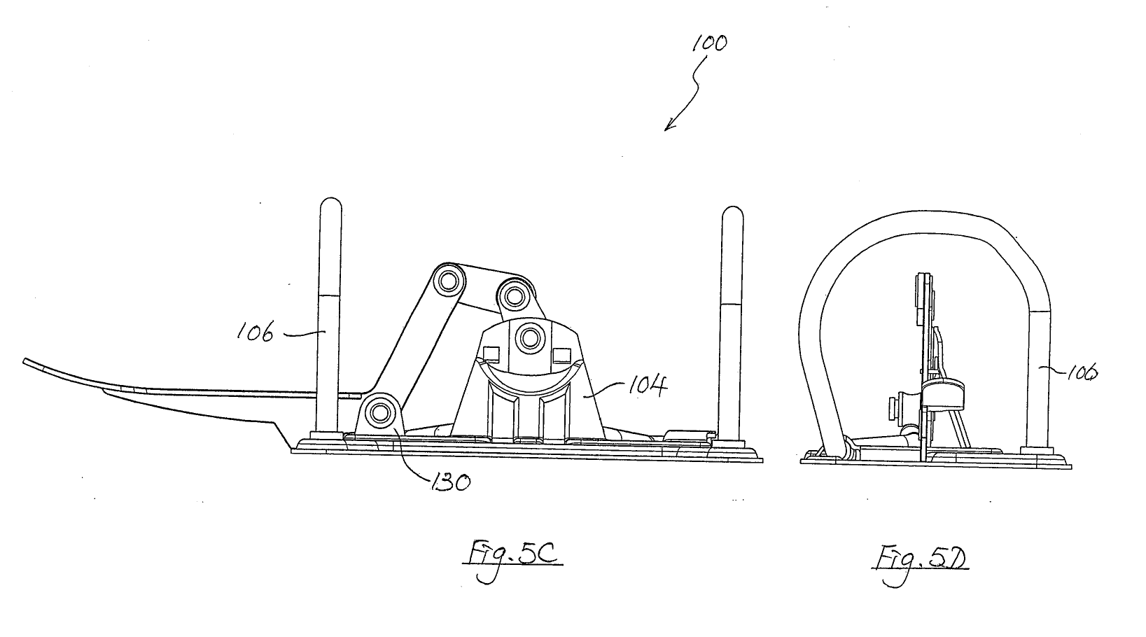

FIG. 5A is a front view of the mechanism shown in FIG. 3;

FIG. 5B is a left side view of the mechanism shown in FIG. 5A;

FIG. 5C is a rear view of the mechanism shown in FIG. 5A;

FIG. 5D is a right side view of the mechanism shown in FIG. 5A;

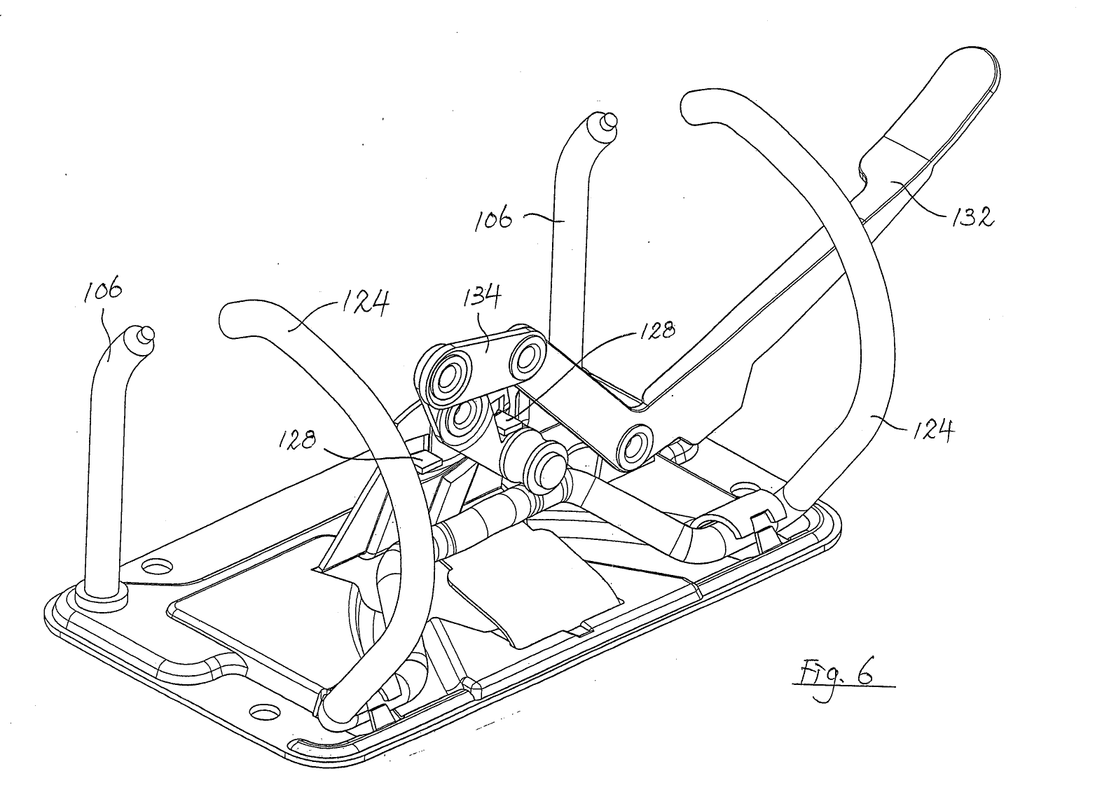

FIG. 6 is a front perspective view of the mechanism shown in FIG. 3 in a ring-open configuration;

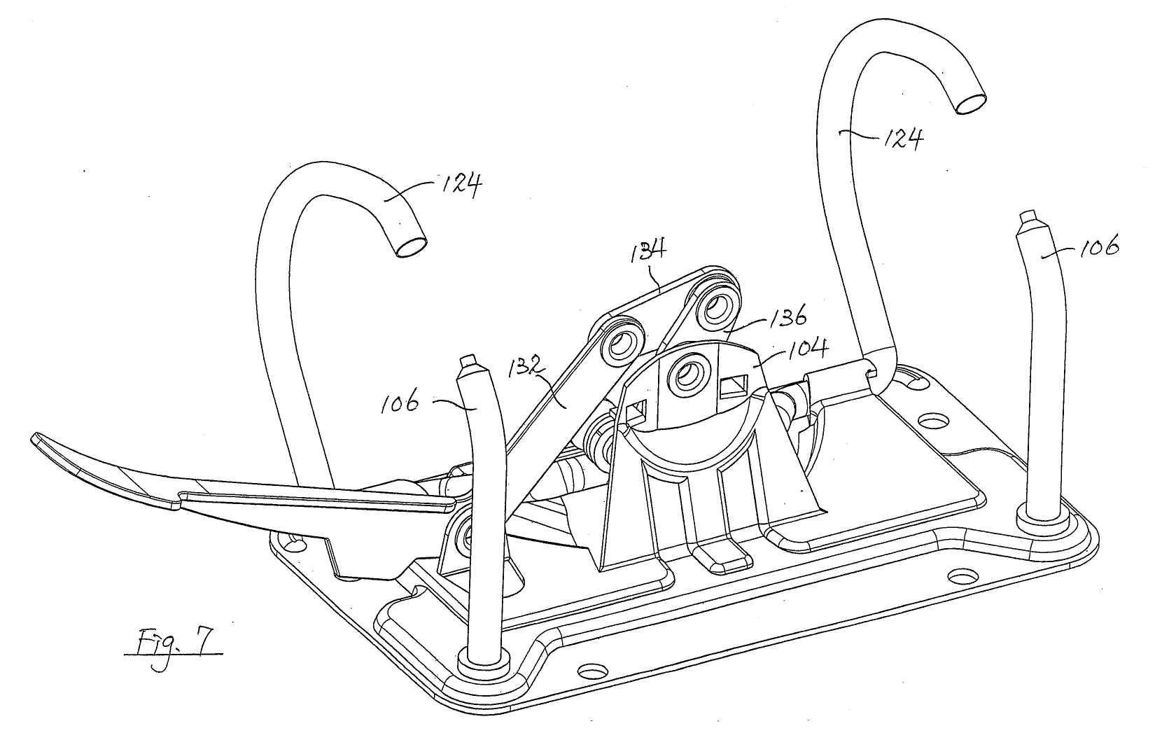

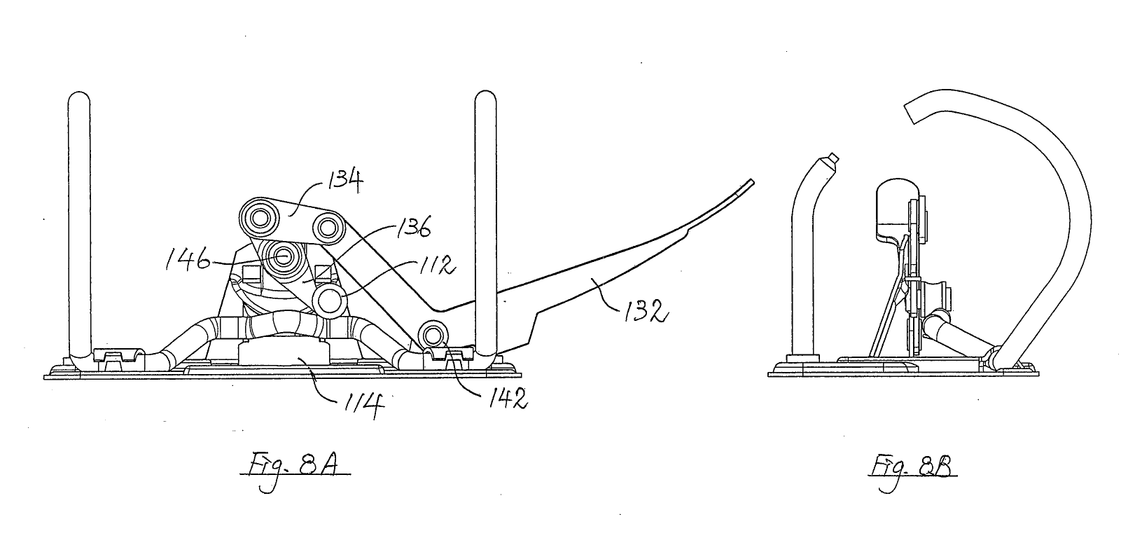

FIG. 7 is a rear perspective of the mechanism shown in FIG. 6;

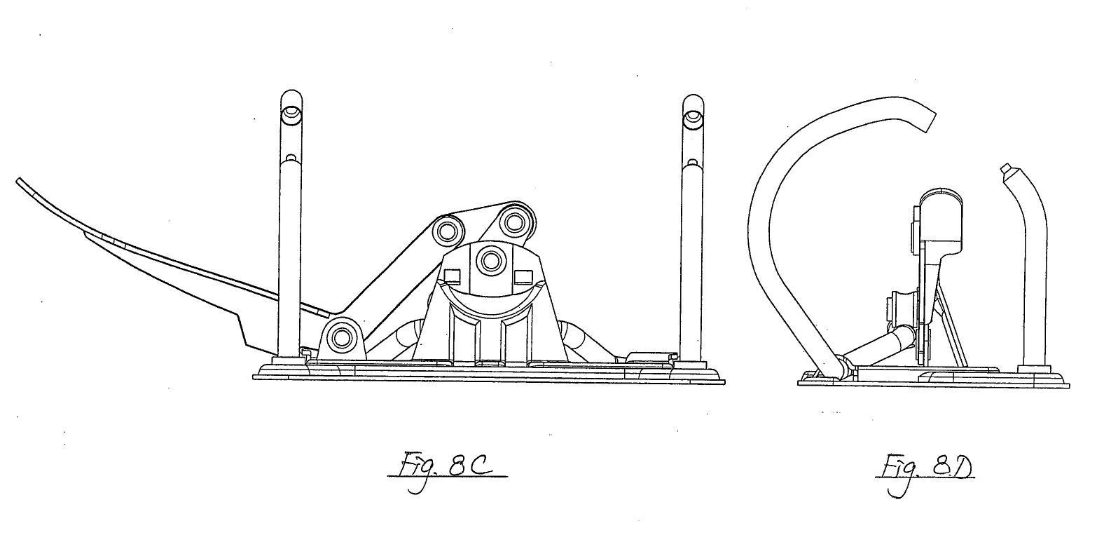

FIG. 8A is a front view of the mechanism shown in FIG. 6;

FIG. 8B is a left side view of the mechanism shown in FIG. 8A;

FIG. 8C is a rear view of the mechanism shown in FIG. 8A;

FIG. 8D is a right side view of the mechanism shown in FIG. 8A;

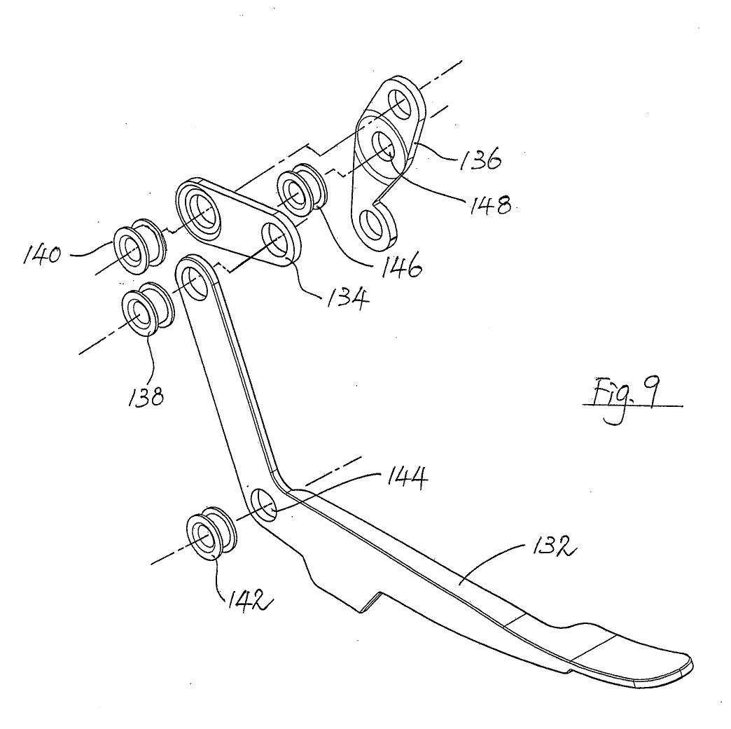

FIG. 9 is an exploded perspective view of the lever assembly of the mechanism shown in FIG. 1A;

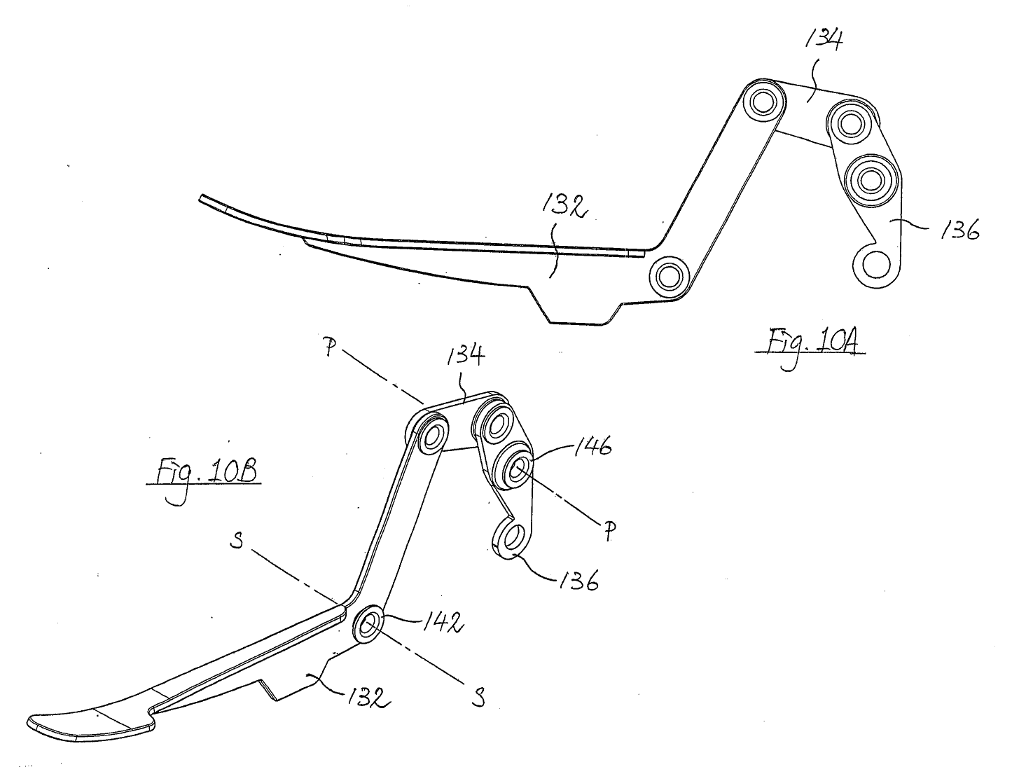

FIG. 10A is a rear view of the lever assembly shown in FIG. 9 when the mechanism is in a ring-closed configuration;

FIG. 10B is a perspective view of the lever assembly shown in FIG. 10A;

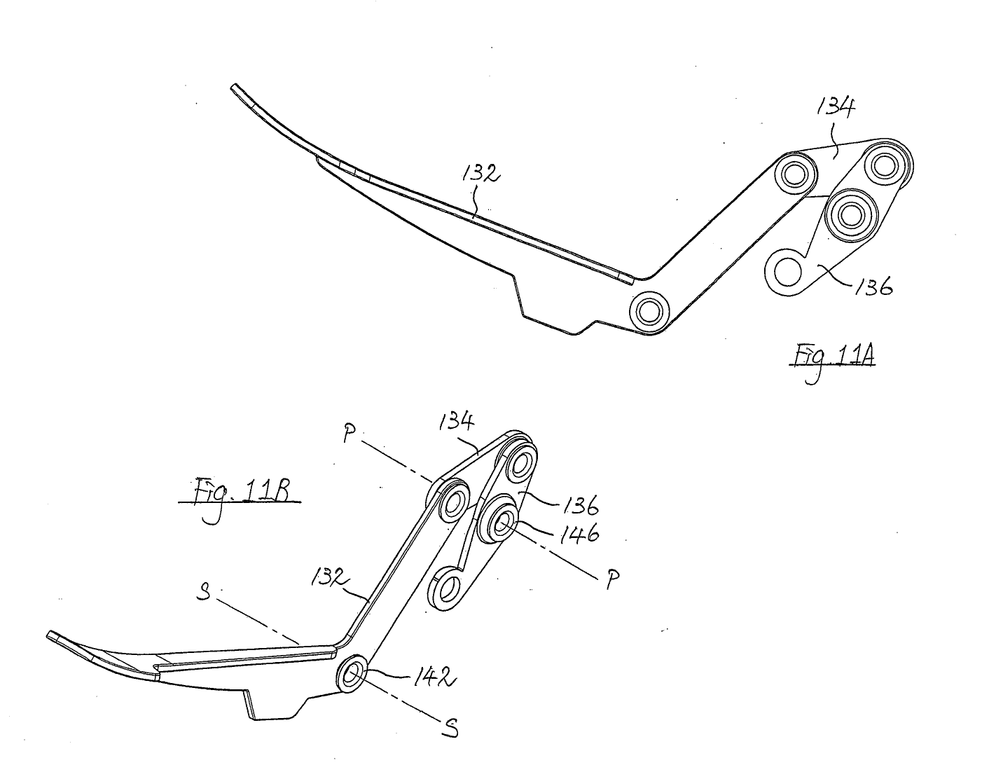

FIG. 11A is a rear view of the lever assembly shown in FIG. 9 when the mechanism is in a ring-open configuration;

FIG. 11B is a perspective view of the lever assembly shown in FIG. 11A;

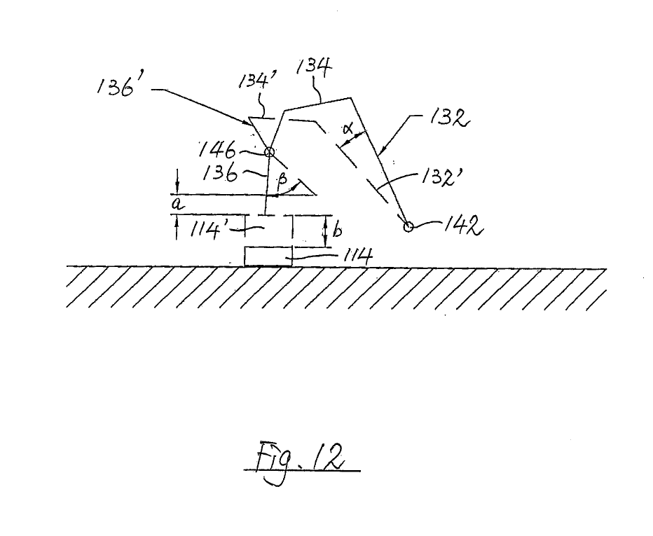

FIG. 12 is a schematic view showing the configurations of the lever assembly shown in FIG. 9 when the mechanism is in the ring-closed configuration and the ring-open configuration respectively;

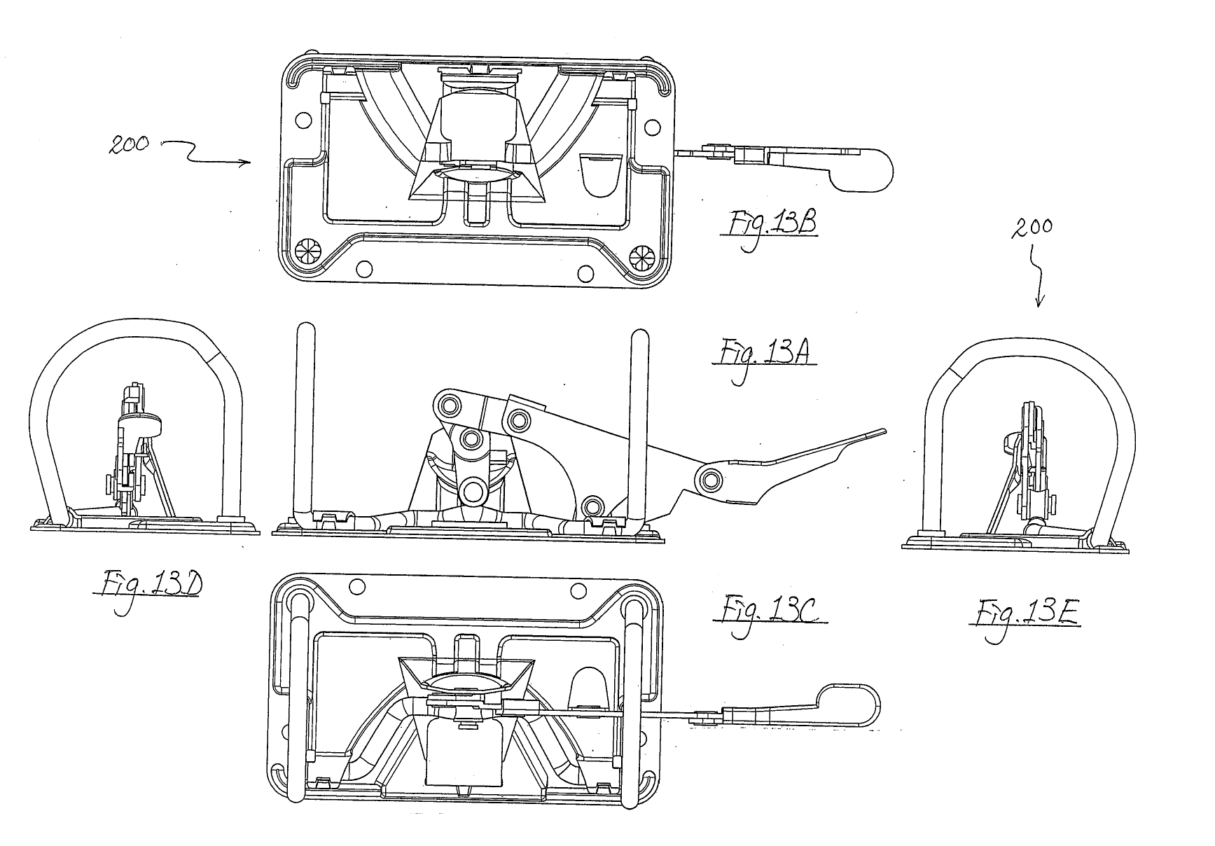

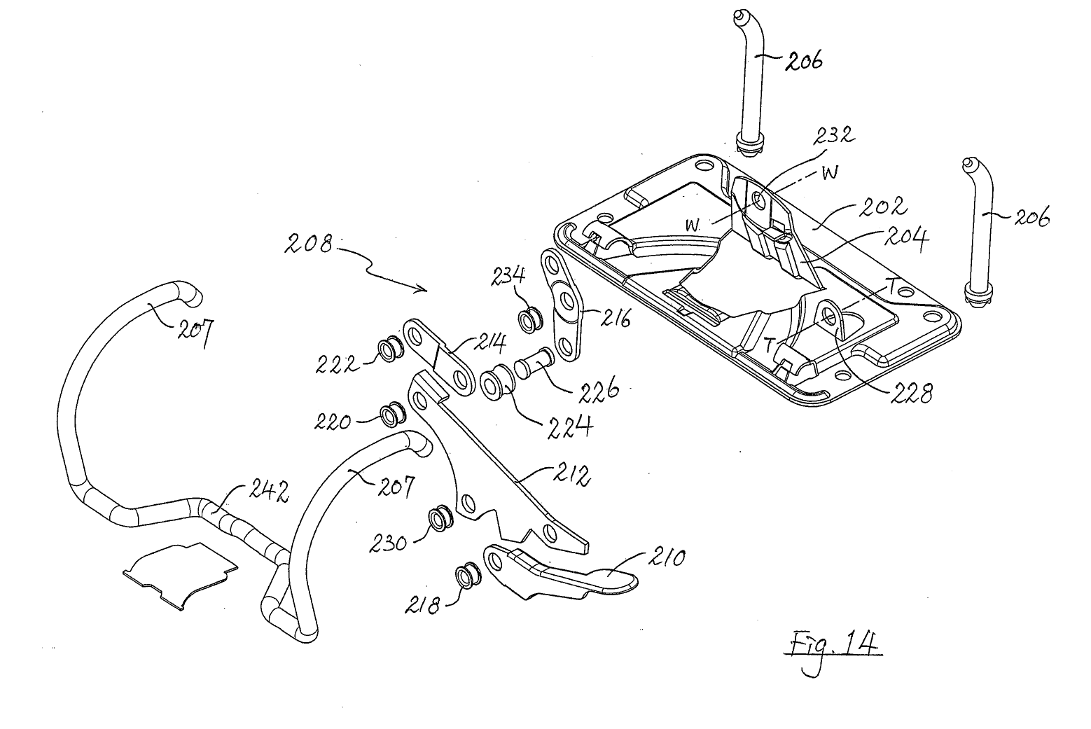

FIG. 13A is a front view of a lever-arch type file mechanism according to a second embodiment of the present invention in a ring-closed configuration;

FIG. 13B is a bottom view of the mechanism shown in FIG. 13A;

FIG. 13C is a top view of the mechanism shown in FIG. 13A;

FIG. 13D is a right side view of the mechanism shown in FIG. 13A;

FIG. 13E is a left side view of the mechanism shown in FIG. 13A;

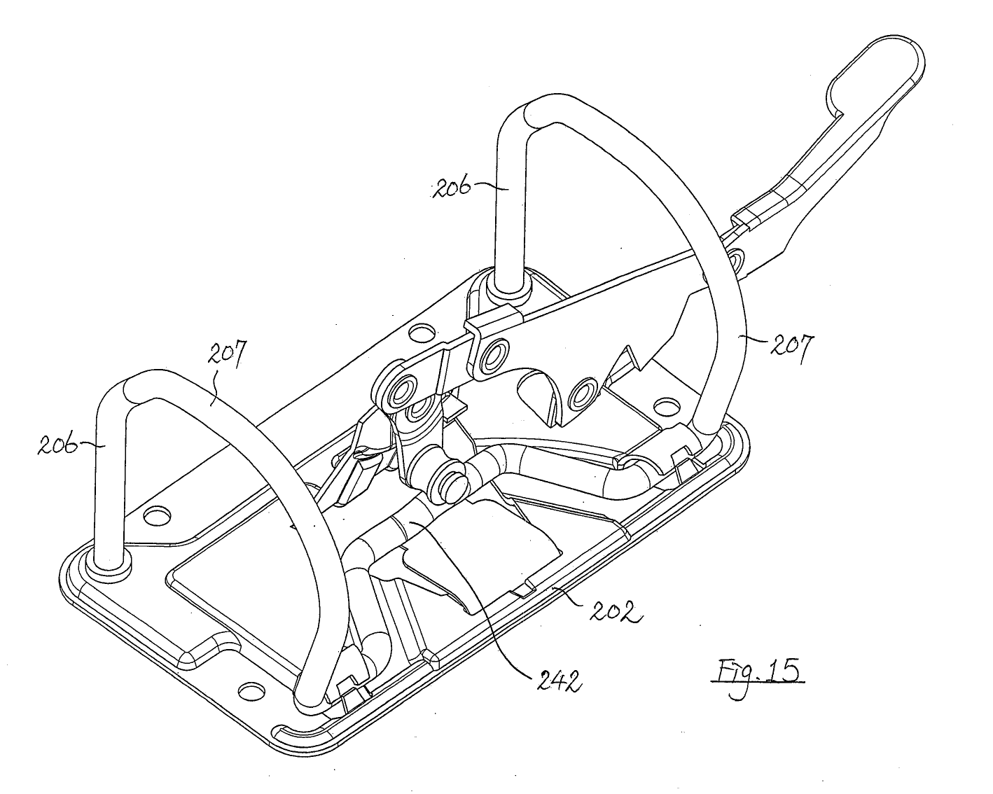

FIG. 14 is an exploded perspective view of the mechanism shown in FIG. 13A;

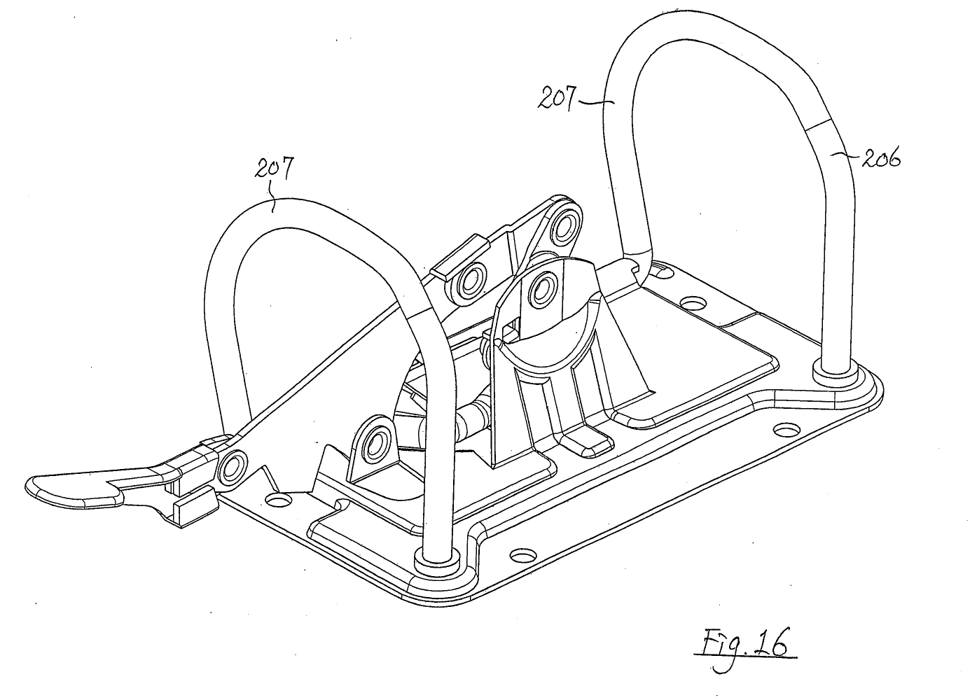

FIG. 15 is a front perspective view of the mechanism shown in FIG. 13A;

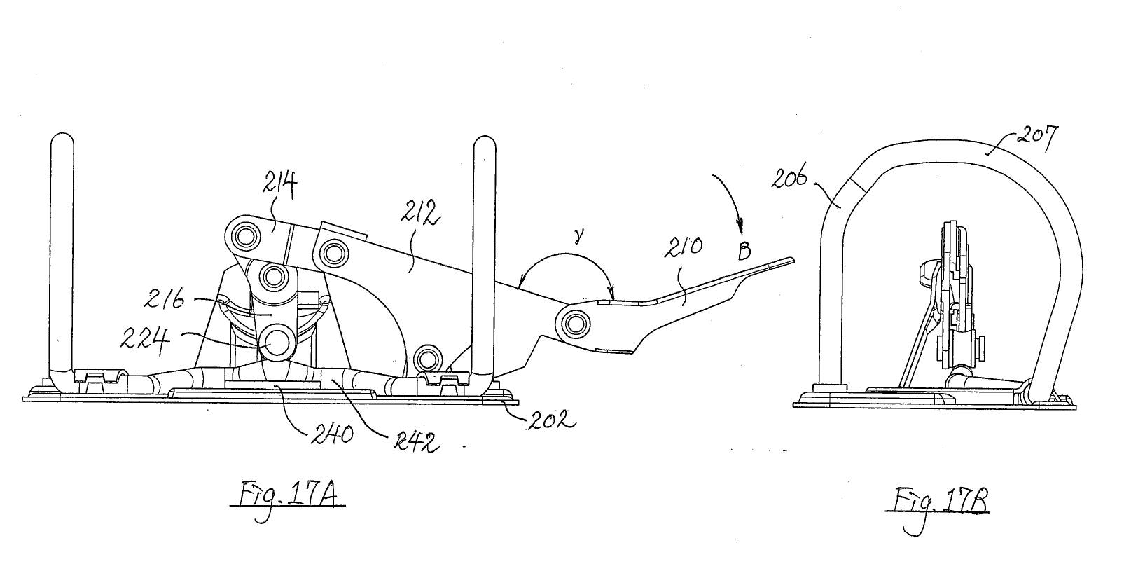

FIG. 16 is a rear perspective view of the mechanism shown in FIG. 13A;

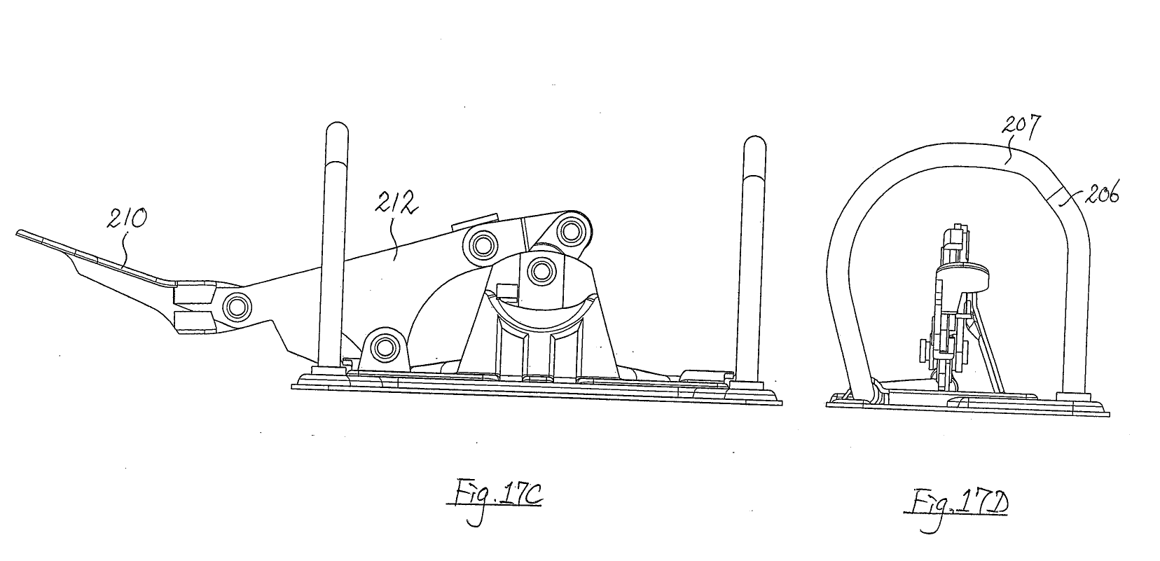

FIG. 17A is a front view of the mechanism shown in FIG. 15;

FIG. 17B is a left side view of the mechanism shown in FIG. 17A;

FIG. 17C is a rear view of the mechanism shown in FIG. 17A;

FIG. 17D is a right side view of the mechanism shown in FIG. 17A;

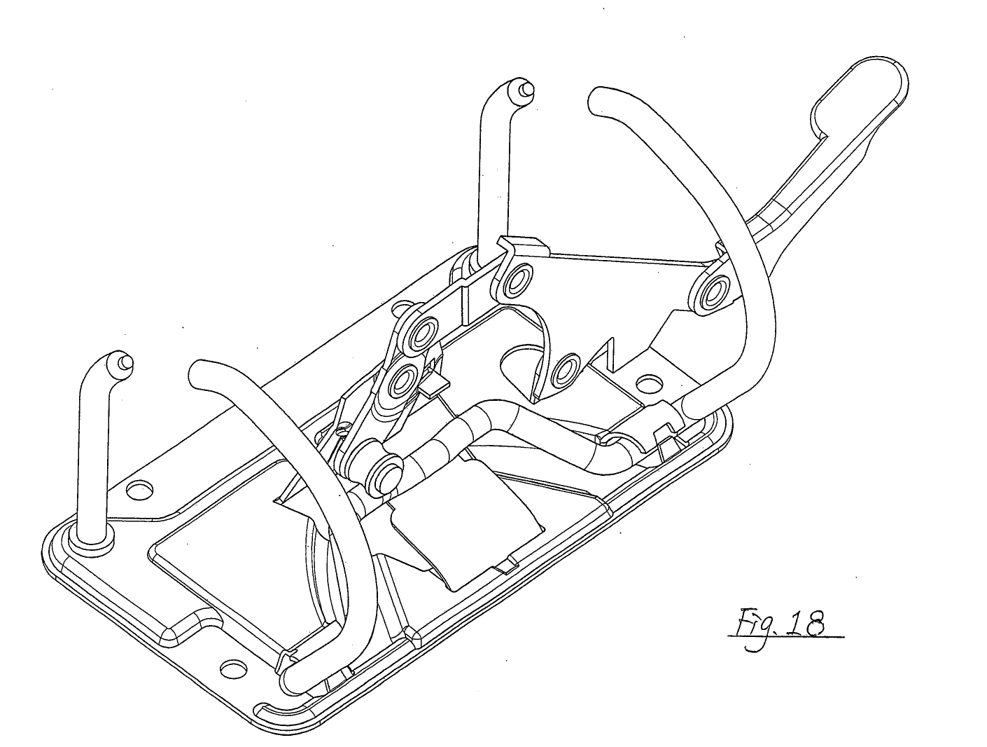

FIG. 18 is a front perspective view of the mechanism shown in FIG. 15 in a ring-open configuration;

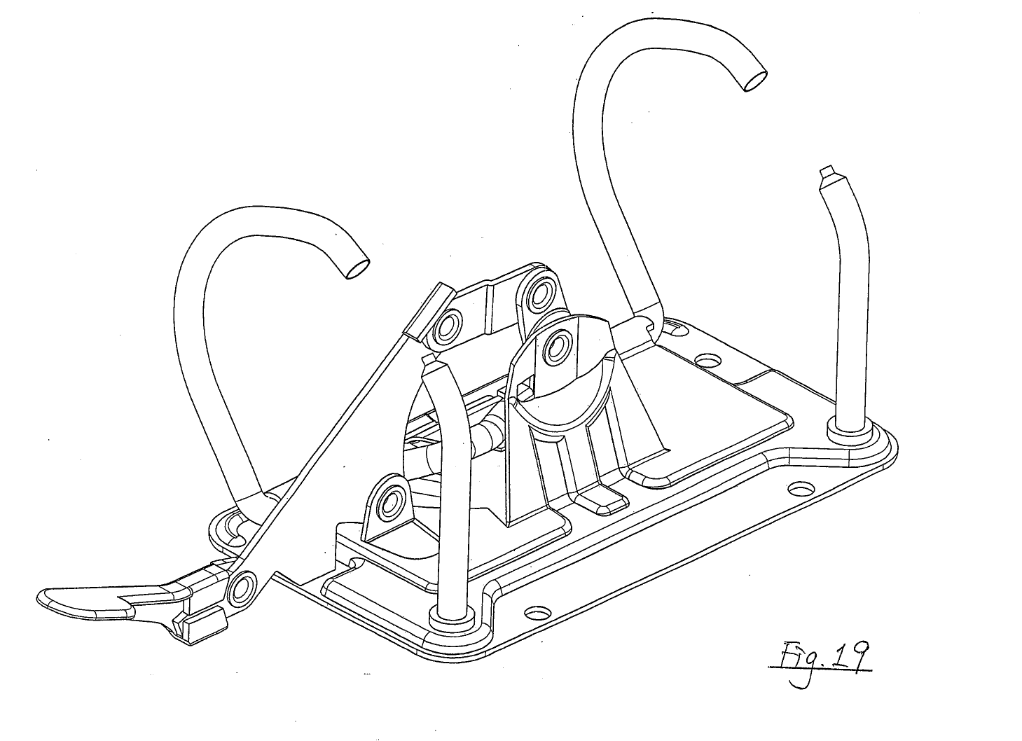

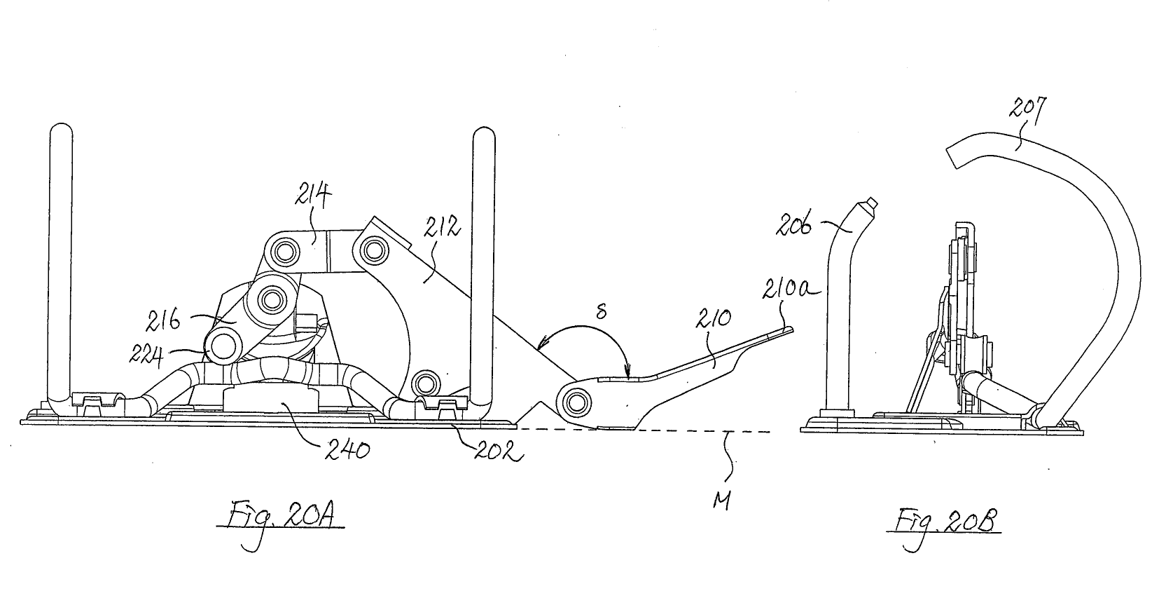

FIG. 19 is a rear perspective of the mechanism shown in FIG. 18;

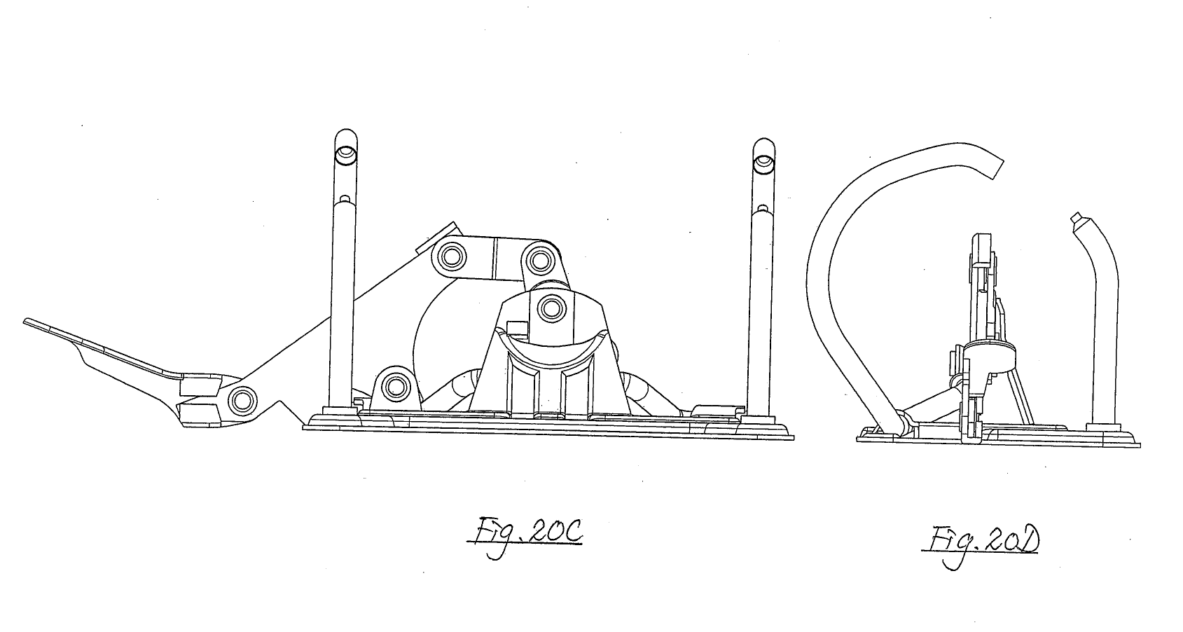

FIG. 20A is a front view of the mechanism shown in FIG. 18;

FIG. 20B is a left side view of the mechanism shown in FIG. 20A;

FIG. 20C is a rear view of the mechanism shown in FIG. 20A;

FIG. 20D is a right side view of the mechanism shown in FIG. 20A;

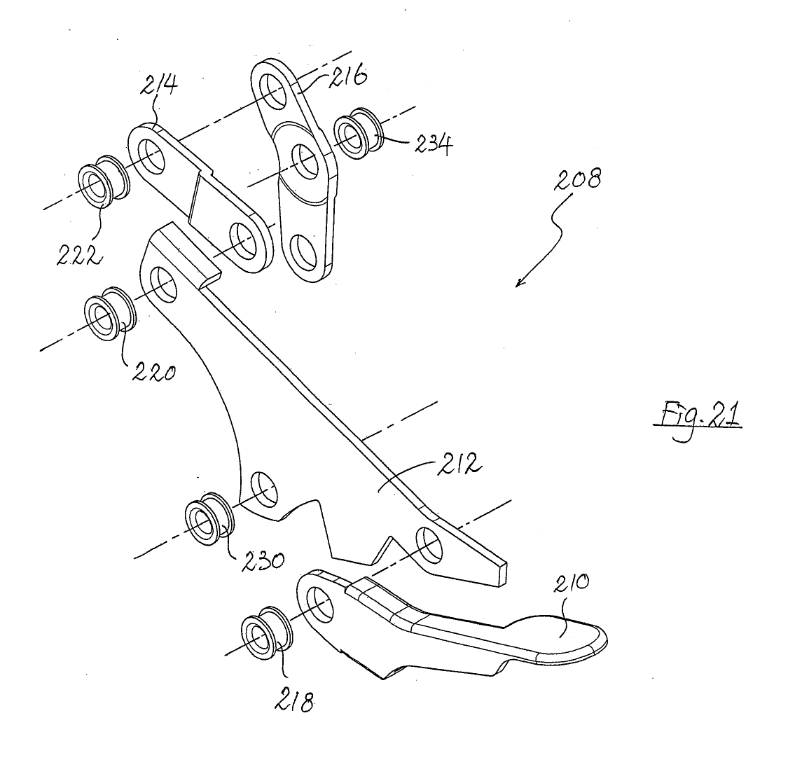

FIG. 21 is an exploded perspective view of the lever assembly of the mechanism shown in FIG. 13A;

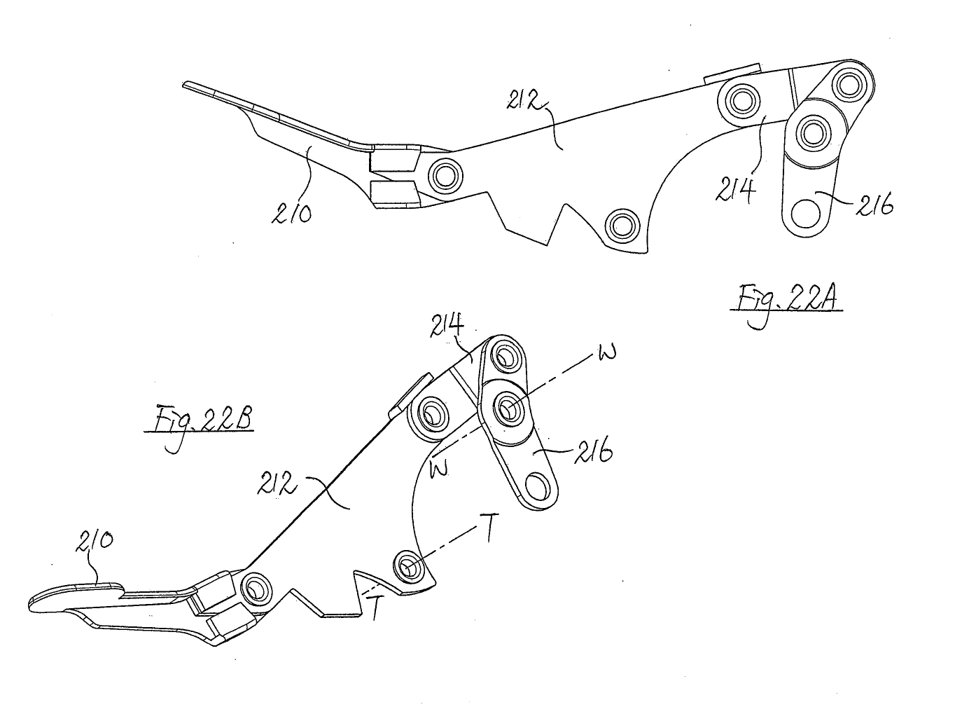

FIG. 22A is a rear view of the lever assembly shown in FIG. 21 when the mechanism is in a ring-closed configuration;

FIG. 22B is a perspective view of the lever assembly shown in FIG. 22A;

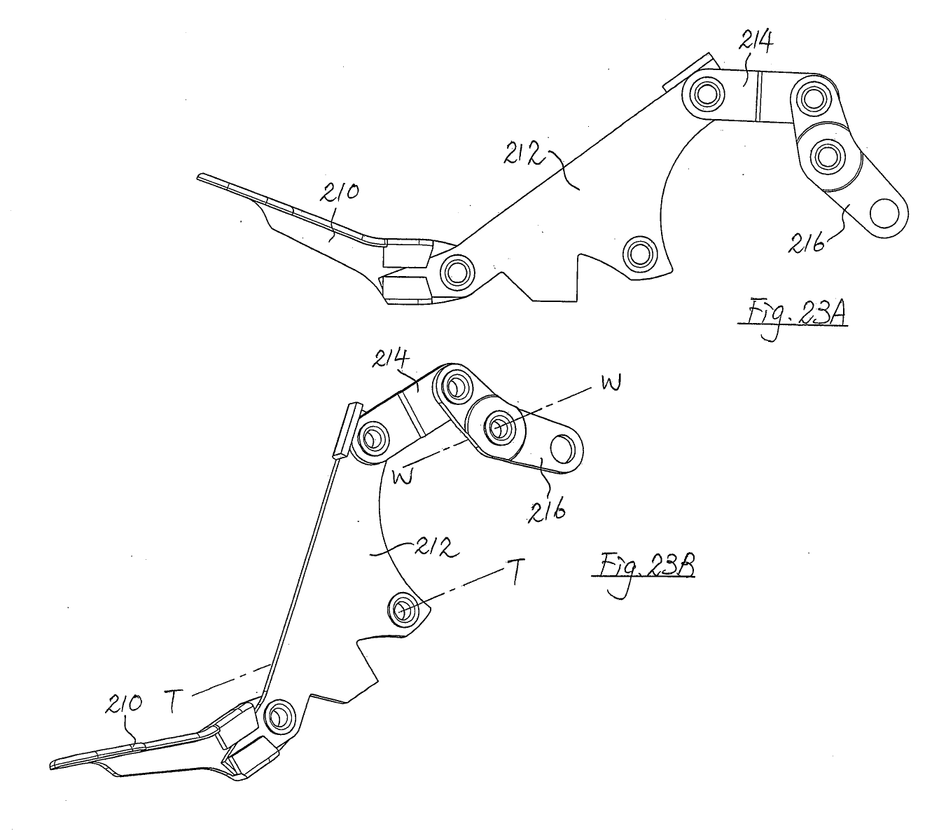

FIG. 23A is a rear view of the lever assembly shown in FIG. 21 when the mechanism is in a ring-open configuration;

FIG. 23B is a perspective view of the lever assembly shown in FIG. 23A;

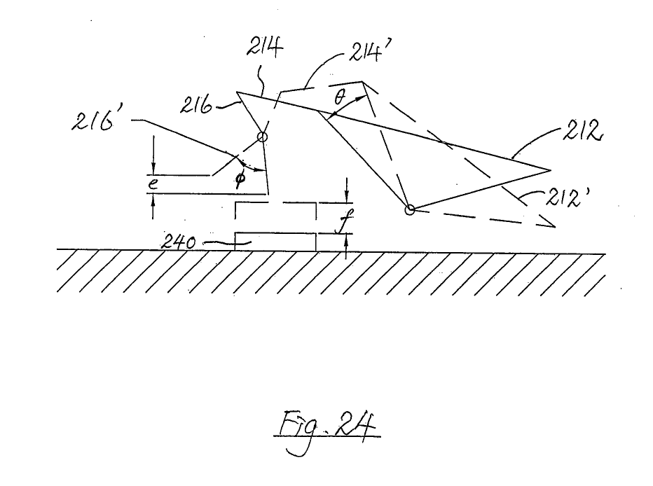

FIG. 24 is a schematic view showing the configurations of the lever assembly shown in FIG. 21 when the mechanism is in the ring-closed configuration and the ring-open configuration respectively

A lever-arch type file mechanism according to a first embodiment of the present invention is shown in FIGS. 1A to 5D, and generally designated as 100. As shown more clearly in FIGS. 2 to 5D, the mechanism 100 includes a generally flat base 102 with an upstanding wall 104 extending from and generally perpendicular to the base 102. The wall 104 is integrally formed with the base 102, e.g. be stamped and bent out from a same metal sheet, and is fixed relative to the base 102. Two posts 106 are fixedly engaged with, and are thus not movable relative to, the base 102.

The mechanism 100 is provided with a hand-operable lever assembly, generally designated as 108. The lever assembly 108 carries, via a pin 110, a roller 112. A resilient spring plate 114 has a first side 116 which is engaged with the base 102 through a slot 118, and an opposite second side 120 which acts on an under side of a shaped portion 122 between and joining two arches 124. In this embodiment, the arches 124 and the shaped portion 122 are integrally with each other, and are thus movable simultaneously. Alternatively, the arches 124 and the shaped portion 122 may be formed separately of one another, and be fixedly engaged with one another for simultaneous movement.

When assembled, and as shown in FIGS. 3 to 5D, the roller 112 rides on and can travel along the shaped portion 122. In the configuration shown in FIGS. 3 to 5D, the respective free ends of the posts 106 and arches 124 mate with each other to form two closed rings, e.g. for retaining pieces of hole-punched paper (not shown). In this ring-closed configuration, the roller 112 is at a higher stable position on the shaped portion 122.

Returning to FIG. 2, it can be seen that a hole 126 is provided through the wall 104. In addition, two protrusions 128 are formed integrally with the wall 104, and they extend generally perpendicular from the wall 104 towards the shaped portion 122.

An ear 130 is formed integrally with, extends from and is generally perpendicular to the base 102. As with the wall 104, the ear 130 may also be stamped and bent out from a same metal sheet with the base 102. The ear 130 is fixed relative to the base 102, and a hole 131 is provided through the ear 130. The longitudinal axis through the hole 126 and the longitudinal axis through the hole 131 are thus both fixed relative to the base 102, and they are parallel to each other. It can also be seen that the distance between the axis through the hole 126 and the base 102 is larger than the distance between the axis through the hole 131 and the base 102. Simply stated, the hole 131 is closer to the base 102 than the hole 126.

As shown in FIGS. 2 and 3, the lever assembly 108 has three links 132, 134 and 136 which are connected with and pivotable relative to one another, in which the link 132 is connected with the link 136 via the link 134. As shown more clearly in FIG. 9, the link 132 is connected with the link 134 by a rivet 138, allowing relative pivotal movement between the links 132 and 134. The link 134 is connected with the link 136 by a rivet 140, allowing relative pivotal movement between the links 134 and 136. The lever assembly 108 is installed to the base 102 by having the link 132 pivotally engaged with the ear 130 by a rivet 142 received through a hole 144 of the link 132 and the hole 131 of the ear 130. The link 132 is thus pivotally movable relative to the ear 130 about an axis fixed relative to the base 102. In addition, the link 136 is pivotally engaged with the wall 104 by a rivet 146 received through a hole 148 of the link 136 and the hole 126 of the wall 104. The link 136 is thus pivotally movable relative to the wall 104 about an axis fixed relative to the base. It can also be seen that while one end of the link 136 is connected with the link 134, another end of the link 136 carries the roller 112 which is freely rotatable relative to the link 136.

With the lever assembly 108 so installed, it may be moved, by manually operating the link 132, between the stable configuration as shown in FIGS. 3 to 5D in which the rings are closed (“ring-closed configuration”) and the stable configuration as shown in FIGS. 6 to 8D in which the rings are open (“ring-open configuration”). In the ring-open configuration, the respective free ends of the posts 106 and arches 124 are out of mating relationship with each other, whereby hole-punched sheets may be retrieved from or inserted into the posts 106 and the arches 124.

By comparing FIGS. 5A and 8A, it can be easily seen that when the link 132 is pivoted upwardly (i.e. in the direction indicated by the arrow A in FIG. 5A) about the axis of the rivet 142, the link 134 is caused to move from the position as shown in FIG. 5A to that shown in FIG. 8A, which in turn causes the link 136 to pivot about the axis of the rivet 146, which is fixed relative to the wall 104, to assume the position shown in FIG. 8A. It can be seen that, by reason of the pivotal movement of the link 136, the roller 112 is raised from the lower stable position shown in FIG. 5A (which is closer to the base 102) to the upper stable position shown in FIG. 8A (which is farther away from the base 102). With such a movement, the spring plate 114 (which acts on the underside of the shaped portion 122) is allowed to spring upwardly to pivot the shaped portion 122 to swivel, thus pivoting the arches 124 away from the posts 106, thus opening the rings. It can be easily seen that subsequent downward pivotal movement of the link 132 will bring the whole lever assembly 108 back to the configuration as shown in FIG. 5A, thus closing the rings formed by the posts 106 and arches 124.

The protrusions 128 extending from the wall 104 act to limit the extent of pivotal movement of the link 136 between the ring-closed configuration and ring-open configuration of the lever assembly 108.

It can be seen from FIGS. 10B and 11B that, and as shown in FIG. 2, the axis P-P about which the link 136 pivots remains fixed relative to the base 102. Similarly, the axis S-S about which the link 132 pivots also remains fixed relative to the base 102.

FIG. 12 shows schematically movement of some of the parts of the mechanism 100 between the ring-closed configuration and the ring-open configuration. The solid lines show the position of the links 132, 134, 136 and the spring plate 114 in the ring-closed configuration and the broken lines show the position of the links (now designated as 132′, 134′ and 136′) and the spring plate (now designated as 114′) in the ring-open configuration. It is found in practice that, by way of the aforesaid arrangement according to the present invention, when the lever assembly 108 is moved from the ring-closed configuration to the ring-open configuration, while the link 132 pivots through an angle α of 18°, the link 136 pivots through an angle β of 53°, which is nearly triple that of the angle α. The magnification of the pivot angle from α to β causes an increase in the vertical distance through which the roller 112 may be raised, as compared with a conventional lever arch type file mechanism. The roller 112 is raised in this instance by a vertical distance a of 3.86 mm. However, because of the shape of the shaped portion 122 (which bulges upwardly in the middle and fall off on both sides along its length), the spring plate 114 is allowed to flex up by a vertical distance b of 6.4 mm, thus allowing a still wider pivoting of the arches 124 away from the posts 106.

The mechanism 100 may be secured, e.g. by rivets, to a substrate, e.g. a cardboard cover, to form a lever-arch type file.

A lever-arch type file mechanism according to a second embodiment of the present invention is shown in FIGS. 13A to 17D, and generally designated as 200. The differences between the mechanism 200 and the mechanism 100 discussed above reside mainly in the structure of a lever assembly generally designated as 208.

As shown more clearly in FIG. 21, the lever assembly 208 has four links, 210, 212, 214, 216 which are connected with one another, either directly or indirectly, and are pivotally movable relative to one another. The link 210 is pivotally engaged with an end of the link 212 through a rivet 218. A second end of the link 212 is pivotally engaged with an end of the link 214 through a rivet 220. Another end of the link 214 is pivotally engaged with an end of the link 216 through a rivet 222. Another end of the link 216 carries a roller 224 via a pin 226.

The link 212 is pivotally engaged with an ear 228 via a rivet 230. As in the case of the mechanism 100 discussed above, the ear 228 is fixed relative to, and extends generally perpendicularly from, a base 202. Such allows the link 212 to pivot about an axis T-T (see FIG. 14) perpendicular to the ear 228 in a seesaw manner. The link 216 is pivotally engaged, via a rivet 234, with a hole 232 through an upstanding wall 204 extending from the base 202.

FIGS. 15 to 17D show the mechanism 200 in a stable ring-closed configuration, in which posts 206 and arches 207 mate with each other to form two closed rings. It can be seen in FIGS. 17A and 17C that when in the ring-closed configuration, the link 210 is at a lower position relative to the link 212, in which the angle between them is γ. When the link 210 is pivoted downwardly in the direction indicated by the arrow B shown in FIG. 17A, it causes consequential downward pivoting movement of the link 212 in the same direction, to the position as shown in FIG. 20A to 20D. The link 214 is then pulled from the position shown in FIG. 17A to that shown in FIG. 20A, which in turn causes the link 216 to swivel in the clockwise direction to the position shown in FIGS. 20A to 20D. The roller 224 is thus raised vertically away from the base 202 whereby a resilient spring plate 240 is allowed to flex up to pivot a shaped portion 242 to cause integrally formed arches 207 to pivot away from the posts 206 to open the rings, so that the mechanism 200 is in a stable ring-open configuration, as shown in FIGS. 20A to 20D.

It can be seen in FIG. 20A that, when the mechanism 200 is in the ring-open configuration, the angle between the links 210 and 212 is δ, which is smaller than the angle γ. In this configuration, in which the angle δ between the links 210 and 212 is smaller than the angle γ between the links 210 and 212 when the link 210 is at a lower position relative to the link 212, the link 210 is said to be in an upper position relative to the link 212. It can also be seen in FIG. 20A that, when in the ring-open configuration, there is a gap between the distal end 210a of the link 210 and a horizontal support surface M, which allows a user to insert his/her finger to pivot the link 210 upwardly to return the mechanism 200 to the ring-closed configuration.

Returning to FIGS. 17C and 20C, it can be seen that the link 210 has an upper inner stopping surface and a lower inner stopping surface for limiting the relative pivotal movement between the link 210 and the link 212. In particular, in the configuration as shown in FIG. 17C, in which the link 210 is said to be in its lower position relative to the link 212, the upper inner stopping surface of the link 210 is in contact with part of an upper edge of the link 212 for preventing further downward pivotal movement of the link 210 relative to the link 212. In the configuration as shown in FIG. 20C, in which the link 210 is said to be in its upper position relative to the link 212, the lower inner stopping surface of the link 210 is in contact with part of a lower edge of the link 212 for preventing further upward pivotal movement of the link 210 relative to the link 212. Such an arrangement also assists in moving the link 212 by operating the link 210. It should also be noted that, when in the configuration shown in FIG. 17C, the link 210 may be moved between its upper and lower positions relative to the link 212 without changing the configuration of the lever assembly 208, and thus that of the rings formed by the posts 206 and arches 207.

FIGS. 22A and 22B show the configuration of the lever assembly 208 when in the ring-closed configuration and FIGS. 23A and 23B show the configuration of the lever assembly 208 in the ring-open configuration.

FIG. 24 shows schematically movement of some of the parts of the mechanism 200 between the ring-closed configuration and the ring-open configuration. The solid lines show the position of the links 212, 214, 216 and the spring plate 240 in the ring-closed configuration and the broken lines show the position of the links (now designated as 212′, 214′ and 216′) and the spring plate (now designated as 240′) in the ring-open configuration. It is found in practice that, by way of the aforesaid arrangement according to the present invention, when the lever assembly 208 is moved from the ring-closed configuration to the ring-open configuration, while the link 212 pivots through an angle θ of 23°, the link 216 pivots through an angle Φ of 59°, which is more than double that of the angle θ. The magnification of the pivot angle from θ to Φ causes an increase in the vertical distance through which the roller 224 may be raised, when compared with a conventional lever-arch type file mechanism. The roller 224 is raised in this instance by a vertical distance e of 3.74 mm. However, because of the shape of the shaped portion 242 (which bulges upwardly in the middle and fall off on both sides), the spring plate 240 is allowed to flex up by a vertical distance f of 6.1 mm, which allows a still wider pivoting of the arches 207 away from the posts 206.

The mechanism 200 may be secured, e.g. by rivets, to a substrate, e.g. a cardboard cover, to form a lever-arch type file.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A lever-arch type file mechanism including:
a base;
at least two rings extending upwardly from the base, each said ring including a post member fixed to said base and an arch member movable relative to said base and said post member;
a lever assembly movable relative to said base between two stable configurations to pivot said arch members relative to said post members to selectively move said rings between a ring-closed configuration and a ring-open configuration;
wherein said lever assembly includes at least a first link member and a second link member connected with each other;
wherein said first link member is pivotable relative to said base about a first axis fixed relative to said base and that said second link member is pivotable relative to said base about a second axis fixed relative to said base.

2. A mechanism according to claim 1 wherein said first link member and said second link member are connected with each other via at least a third link member.

3. A mechanism according to claim 1 wherein said first link member is pivotable downwardly to open said rings.

4. A mechanism according to claim 1 wherein said first link member is pivotable upwardly to open said rings.

5. A mechanism according to claim 2 wherein a first end of said first link member is connected with said third link member and a second end of said first link member carries an actuator movable along a shaped portion joining and between said arch members.

6. A mechanism according to claim 2 wherein a first end of said second link member is connected with said third link member and a second end of said second link member is connected with a fourth link member.

7. A mechanism according to claim 6 wherein said fourth link member is pivotable relative to said second link member between an upper position and a lower position.

8. A mechanism according to claim 6 wherein when said rings are in said ring-closed configuration, said fourth link member is pivotable relative to said second link member without changing the configuration of said lever assembly.

9. A mechanism according to claim 7 wherein said fourth link member is biased towards said lower position.

10. A mechanism according to claim 9 wherein said fourth link member is biased towards said lower position by its weight.

11. A mechanism according to claim 1 wherein including means for limiting the extent of pivotal movement of said first link member relative to said base member.

12. A mechanism according to claim 1 wherein the distance between said first axis and said base is larger than the distance between said second axis and said base.

13. A lever-arch type file mechanism including:
a base;
at least two rings extending upwardly from including a post member fixed to said base and relative to said base and said post member;
a lever assembly movable relative to said base between two stable configurations to pivot said arch members relative to said post members to selectively move said rings between a ring-closed configuration and a ring-open configuration;
wherein said lever assembly includes at least a first link member and a the base, each said ring an arch member movable second link member connected with each other;
wherein during movement of said lever assembly between said two stable configurations, said first link member is pivotable relative to said base through a first angle and that said second link member is pivotable relative to said base through a second angle which is different from said first angle.

14. A mechanism according to claim 13 wherein said first link member carries an actuator movable along a shaped portion joining and between said arch members.

15. A mechanism according to claim 13 wherein that said first angle is larger than said second angle.

16. A mechanism according to claim 13 wherein that said first link member and said second link member are connected with each other via a third link member.

17. A mechanism according to claim 13 wherein that said second link member is pivotable downwardly to open said rings.

18. A mechanism according to claim 13 wherein said second link member is pivotable upwardly to open said rings.

19. A mechanism according to claim 16 wherein a first end of said second link member is connected with said third link member and a second end of said second link member is connected with a fourth link member.

20. A mechanism according to claim 19 said fourth link member is pivotable relative to said second link member between an upper position and a lower position.

21. A mechanism according to claim 20 wherein when said rings are in said ring-closed configuration, said fourth link member is pivotable relative to said second link member without changing the configuration of said lever assembly.

22. A mechanism according to claim 20 that wherein said fourth link member is biased towards said lower position.

23. A mechanism according to claim 22 wherein said fourth link member is biased towards said lower position by its weight.

24. A mechanism according to claim 13 wherein including means for limiting the extent of pivotal movement of said first link member relative to said base member.

25. A mechanism according to claim 15 wherein said first angle is at least twice as large as said second angle.

26. A lever-arch type file including a lever-arch type file mechanism according to claim 1 fixedly secured to a substrate.
